(19) United States
(12) Patent Application Publication
(10) Pub. No.: US 2009/0101715 A1
(43) Pub. Date: Apr. 23, 2009

(54) Electronic-card reader structure

(76) Inventors: Feng-Yen Lu, Taipei City (TW); Yu-Hsien Lien, Sinjhuang City (TW); Chun-Kai Wang, Banciao (TW); Yin-Chen Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,718

(22) Filed: Oct. 17, 2007

(51) Int. Cl. G06K 7/06

(52) U.S. Cl. 235/441

(57) ABSTRACT

An electronic-card reader structure includes a first plate, and a second plate. A printed circuit board is disposed between the first and the second plates. Two ends of the covering are respectively connected with the first plate and the second plate. The position of the covering is correspondingly to the printed circuit board. The first plate, the second plate and the covering are constructed as a rectangle casing with a dimension of a floppy disk. The built-in electronic-card reader structure has better mechanical and structural strength and the material for manufacturing the electronic-card reader structure is further reduced.

### BACKGROUND OF THE INVENTION

1. Field of the Invention

The present invention relates to an electronic-card reader structure and in particular to a built-in electronic-card reader structure with high mechanical strength.

2. Description of Prior Art

The electronic products are widely used in our modern life, such as computers, mobile phones, and variety of 3C applications. In addition, the electronic cards are supported in mobile electronic applications, such as mobile phones, electronic dictionary, digital cameras, PDA, and laptop computers and the electronic cards can be inserted into the electronic card devices so that the data can be transmitted from the electronic cards to the main device or vise versa. Furthermore, the data or functions can be upgraded using the transmission of the electronic cards.

However, electronic cards are classified into different specifications such as Multi-Media Cards (MMCs), Secure Digital Cards (SDs), and Memory Stick Cards (MSs). The above described electronic cards with different specifications are used in different devices and are produced by various corporations. A card connector having multiple-abilities for reading/writing data in the electronic cards with various specifications is necessary for a consumer.

Generally speaking, electronic cards readers are classified into two types, built-in card reader and external card reader. External card readers usually connect with the main server by USB connection or another connecting method and built-in card readers are directly assembled in the casing of the main server. FIGS. 1 and 2 show two types of the related built-in card readers. Please refer to FIG. 1, the first type of the card reader is a rectangle body assembled by a top casing 100 and a bottom casing 200. A circuit board 12′ is disposed between the top casing 100 and the bottom casing 200. When an electronic card is inserted into the card reader, the electronic card is connected electrically with the circuit board so that the data restored in the electronic card can be read. On the other hand, the second type of the built-in card reader is shown in FIG. 2. Similarly, the card reader is constructed by a top casing 100′ and a bottom casing 200′. The difference between FIG. 1 and FIG. 2 is the circuit board is exposed out form the casing. Briefly speaking, the both card readers in FIGS. 1 and 2 are formed by combining top and bottom casings. The shape of the top and bottom casings is plate-like shape and manufacturing the plate-shaped casing spends too much material to reduce the manufacturing cost.

Therefore, in view of this, the inventor proposes the present invention to overcome the above problems based on his expert experience and deliberate research.

### SUMMARY OF THE INVENTION

The primary object of the present invention is provided for an electronic-card reader structure. The card reader structure can be assembled in the computer casing and the manufacturing cost and material are reduced.

Another object of the present invention is to provide an electronic-card reader structure. The mechanical strength of the card reader structure meets the structural requirement for supporting the electronic devices.

In order to achieve the above objects, the present invention provides an electronic-card reader structure. The electronic-card reader structure comprises: a first plate; a second plate; a printed circuit board disposed between the first plate and the second plate; and a covering having two ends thereon, wherein the two ends are respectively connected with the first plate and the second plate and the covering is disposed correspondingly to the printed circuit board; wherein the first plate, the second plate and the covering are constructed as a casing with a dimension of a floppy disk.

In order to achieve the above objects, the present invention provides an electronic-card reader structure. The electronic-card reader structure comprises: a first plate; a second plate; a third plate connected between one end of the first plate and one end of the second plate; an printed circuit board disposed between the first plate and the second plate; and a covering disposed on the third plate wherein the covering is disposed correspondingly to the printed circuit board; wherein the first plate, the second plate and the third plate are constructed as a casing with a dimension of a floppy disk.

The U-shaped plate is replaced for the plate-like casing and the material of the casing is reduced. Furthermore, the reader structure has enough mechanical and the structural strength for usage.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is a schematic view showing the first type of the electronic-card reader structure according to the prior art.

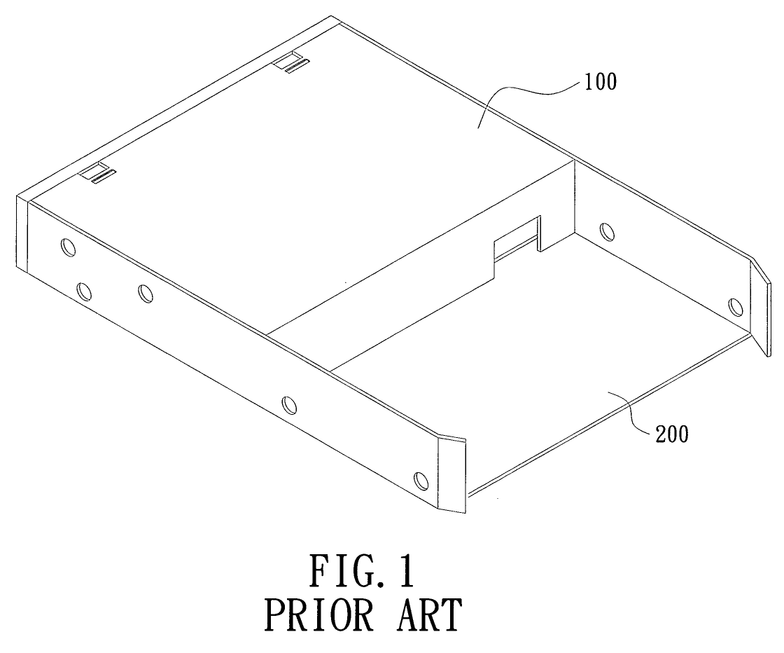

FIG. 2 is a schematic view showing the second type of the electronic-card reader structure according to the prior art.

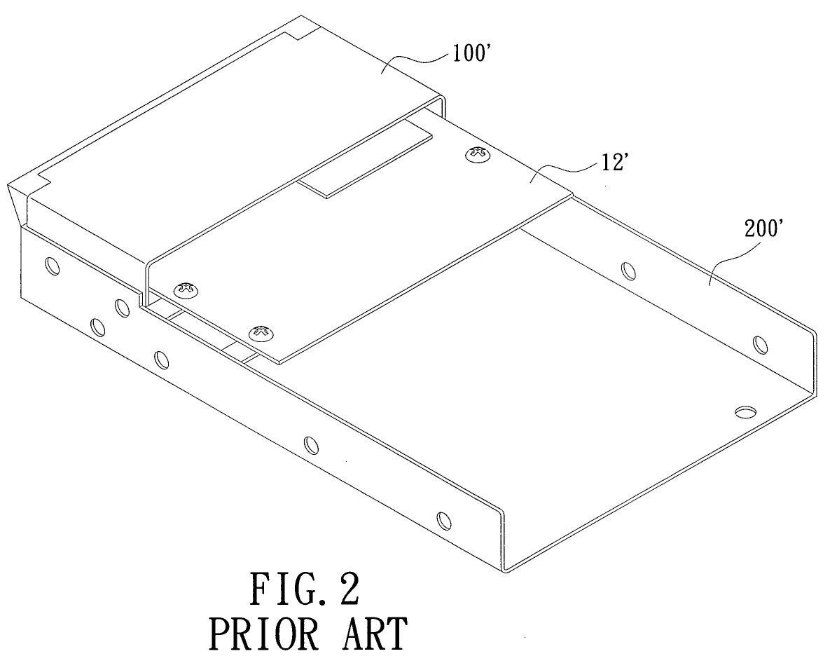

FIG. 3A is an exploded perspective view showing the second embodiment of the electronic-card reader structure according to the present invention.

FIG. 3B is a schematic view showing the first embodiment of the electronic-card reader structure according to the present invention.

FIG. 4 is a schematic view showing the electronic-card reader structure is inserted into the floppy disk slot according to the present invention.

FIG. 5 is a schematic view showing the second embodiment of the electronic-card reader structure according to the present invention.

### DETAILED DESCRIPTION OF THE INVENTION

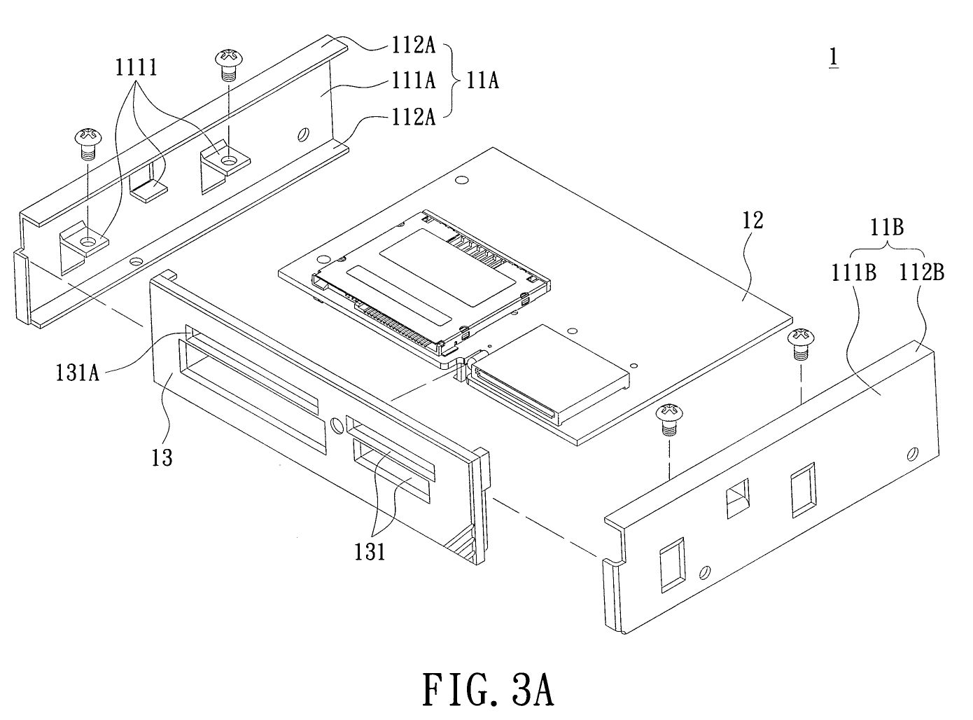

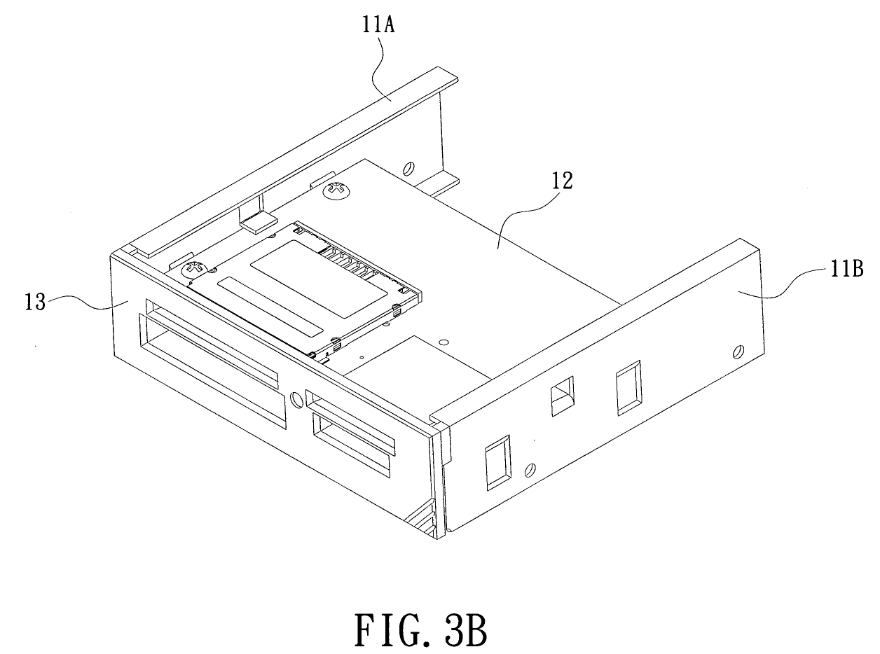

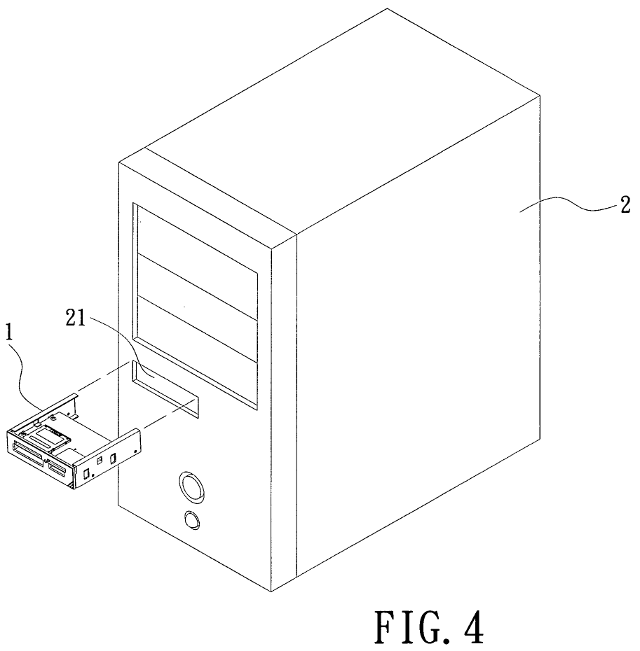

Please refer to FIGS. 3A to 5, the invention discloses a built-in electronic-card reader structure 1 and the electronic-card reader structure 1 can be directly inserted into the floppy disk slot 21 on the computer case 2. The electronic-card reader structure 1 is connected electrically with the motherboard so that when an electronic-card is inserted into the electronic-card reader structure 1, a user can access, read or save data in the electronic-card. The electronic-card reader structure 1 comprises a first plate 11A, a second plate 11B, a printed circuit board (PCB) 12 disposed between the first plate 11A and the second plate 11B, and a covering 13. The covering 13 has two ends and the two ends are connected with the first plate 11A and the second plate 11B. The position of the covering 13 is correspondingly to the printed circuit board 12. The first plate 11A, the second plate 11B and the covering 13 are constructed as a rectangle casing with a dimension of a floppy disk and sized in compliance with floppy disk configuration. In other words, the size of the casing formed by connecting the first plate 11A, the second plate 11B and the covering 13 is corresponding to the floppy disk slot 21. Therefore, the electronic-card reader structure 1 is assembled with the computer case 2.

Please refer FIGS. 3A and 3B, the first embodiment of the present invention is shown. One end of the first plate 11A and one end of the second plate 11B are respectively connected with the two ends of the covering 13 by any method of connecting, such as gluing, or latching. The height and the weight of the casing constructed by the first plate 11A, the second plate 11B and the covering 13 are matched with the height and the weight of the floppy disk slot. On the other hand, the length of the casing is not restricted.

Furthermore, the first plate 11A and the second plate 11B are substantially U-shaped plates. The U-shaped plate is provided for better mechanical strength of the electronic-card reader structure 1. In detail, the first plate 11A and the second plate 11B further comprise main portions 111A and 111B. Two side portions 112A are formed by bending the two sides of the main portions 111A. Similarly, two side portions 112B are formed by bending the two sides of the main portions 112A. In other words, one side of the electronic-card reader structure 1 has two side portions 112A respectively on the upper and bottom ends and the other side of the electronic-card reader structure 1 has two side portions 112B respectively on the upper and bottom ends. The side portions 112A and 112B are provided for a guiding effect when the electronic-card reader structure 1 is inserted into the computer case 2 so that the insertion of the electronic-card reader structure 1 is smoother. Moreover, the side portions 112A and 112B also provide a supporting effect for increasing the mechanical strength of the casing.

The main portions 111A and 111B of the first plate 11A and the second plate 11B have a plurality of fixing portions 1111. The fixing portions 1111 are used for fixing the printed circuit board 12 on the first plate 11A and the second plate 11B. Two ends of the printed circuit board 12 are respectively mount onto the fixing portions 1111 of the first plate 11A and the second plate 11B by strewing. The mounting method is not restricted to the above mentioned method. The fixing portions 1111 are respectively integrally formed with the first plate 11A and the second plate 11B. In other words, the fixing portions 1111 of the first plate 11A are formed by bending the material of the first plate 11A and the fixing portions 1111 of the second plate 11B are formed by bending the material of the second plate 11B. Thus the material for manufacturing the casing can be reduced.

On the other hand, two ends of the covering 13 are connected the first plate 11A and the second plate 11B by wedging or fastening methods. The covering 13 has a plurality of slots 131 thereon. The slots 131 are corresponding to the dimensions of different electronic-cards. For example, the MS card can be inserted into the slot 131A. Accordingly, different electronic-cards are inserted into the relative slots 131 so that a user can save, delete or read data in the electronic-cards when the cards are inserted in the slots 131.

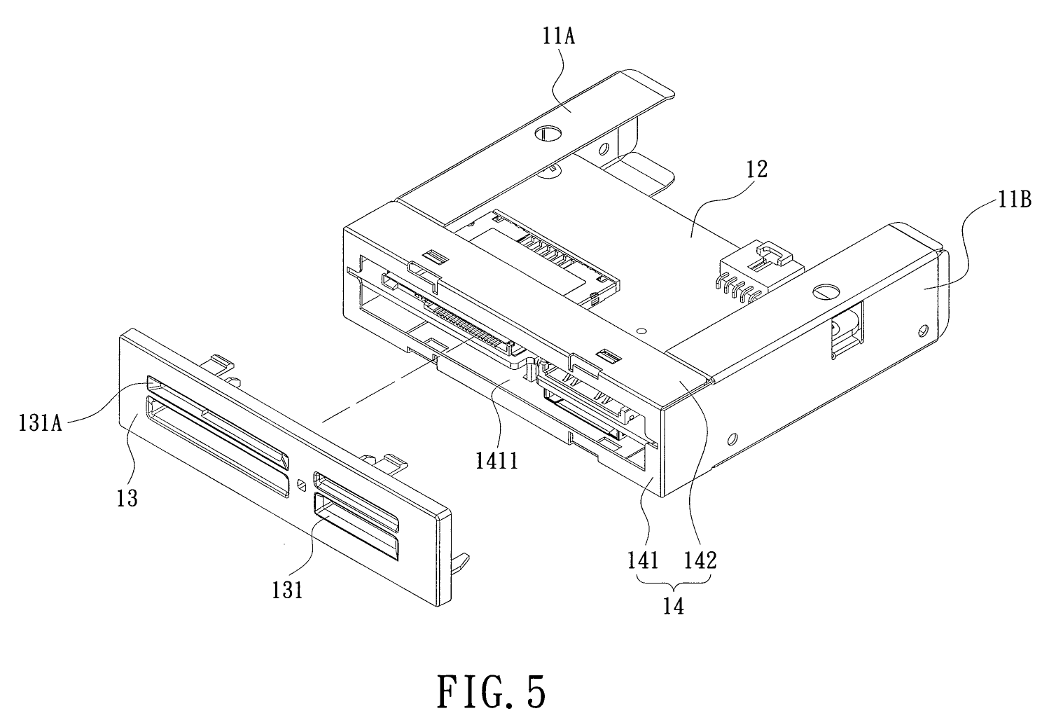

Please refer to FIG. 5, the second embodiment of the present invention is shown. One end of the first plate 11A extends to one end of the second plate 11B so as to form a third plate 14. The third plate 14 is also substantially a U-shaped plate for providing a better strength. The third plate 14 has a main portion 141 and two side portions 142 formed by bending the two sides of the main portion 141. The main portion 141 has an opening 1411 for passing the electronic-cards therethrough. Moreover, the covering 13 is assembled with the third plate 14 by screwing or the other connecting methods. The covering 13 has a plurality of slots 131 thereon. The slots 131 are corresponding to the dimensions of different electronic-cards. For example, the MS card can be inserted into the slot 131A. Accordingly, different electronic-cards are inserted into the relative slots 131 so that a user can save, delete or read data in the electronic-cards when the cards are inserted in the slots 131 and passing through the opening 1411 in order to connect electrically with motherboard in the computer 2.

The structure of the present invention has better strength and stronger mechanism due to the mechanical properties of the U-shaped plate. The electronic-card reader structure 1 also provides improved electrical characteristics, such as electrical and magnetic shielding effect. Furthermore, the manufacturing cost and the material for manufacturing are reduced.

To sum up, the present invention achieves the following advantages:
1. The electronic-card reader structure 1 is constructed by at least one U-shaped plate and the mount of material for manufacturing the structure is less than the related structure with an upper and a bottom plate. In other words, the manufacturing cost of the present invention is further reduced.
2. The U-shaped plate is provided for constructing the electronic-card reader structure 1 and the strength of the electronic-card reader structure is meeting the mechanical requirement.

Although the present invention has been described with reference to the foregoing preferred embodiment, it will be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. An electronic-card reader structure comprising:
a first plate;
a second plate;
a printed circuit board disposed between the first plate and the second plate; and
a covering having two ends thereon, wherein the two ends are respectively connected with the first plate and the second plate, and the covering is disposed correspondingly to the printed circuit board;
wherein the first plate, the second plate and the covering are constructed as a casing with a predetermined dimension sized in compliance with floppy disk configuration.

2. The electronic-card reader structure according to claim 1, wherein the first plate and the second plate are U-shaped plates.

3. The electronic-card reader structure according to claim 2, wherein each of the U-shaped plate comprises a main portion and two side portions bended from two sides of the main portion.

4. The electronic-card reader structure according to claim 3, wherein the main portion comprises a plurality of fixing portions for fixing the printed circuit board.

5. The electronic-card reader structure according to claim 1, wherein the covering has a plurality of slots thereon.

6. The electronic-card reader structure according to claim 5, wherein the slots are provided for inserting electronic-cards with different standards.

7. An electronic-card reader structure, comprising:
a first plate;
a second plate;
a third plate connected between one end of the first plate and one end of the second plate;
an printed circuit board disposed between the first plate and the second plate; and
a covering disposed on the third plate wherein the covering is disposed correspondingly to the printed circuit board;
wherein the first plate, the second plate and the third plate are constructed as a casing with a predetermined dimension sized in compliance with floppy disk configuration.

8. The electronic-card reader structure according to claim 7, wherein the first plate, the second plate and the third plate are U-shaped plates.

9. The electronic-card reader structure according to claim 8, wherein each of the U-shaped plate comprises a main portion and two side portion bended from two sides of the main portion.

10. The electronic-card reader structure according to claim 9, wherein the main portion comprises a plurality of fixing portions for fixing the printed circuit board.

11. The electronic-card reader structure according to claim 9, wherein the main portion of the third plate has an opening thereon.

12. The electronic-card reader structure according to claim 11, wherein the covering has a plurality of slots thereon.

13. The electronic-card reader structure according to claim 12, wherein the slots are provided for inserting electronic-cards with different standards to connect electrically to the printed circuit board through the opening of the third plate.
